(19) United States
(12) Patent Application Publication
(10) Pub. No.: US 2002/0194354 A1
(43) Pub. Date: Dec. 19, 2002

(54) Displaying image data

(75) Inventors: Marc Bolduc, St. Luc (CA); Stephane Duchesne, Chambly (CA)

Correspondence Address: GATES & COOPER LLP, HOWARD HUGHES CENTER, 6701 CENTER DRIVE WEST, SUITE 1050, LOS ANGELES, CA, 90045, US

(73) Assignee: DISCREET LOGIC INC.

(21) Appl. No.: 09/928,598

(22) Filed: Aug. 13, 2001

(30) Foreign Application Priority Data
Apr. 19, 2001 (GB) GB/01/09/621.3

(51) Int. Cl. G06F 15/16

(52) U.S. Cl. 709/231; 725/88

(57) ABSTRACT

A method of viewing a clip of image data stored (109) remotely on a network (106). The viewing is performed by an image processing station (101) connected to the network. Frames of a clip are prefetched (701) and certain of the frames in a frame sequence are skipped, in alternation with frames that are fetched. Frames are skipped to compensate for network conditions. Display (702) of the prefetched frames is performed by selecting (1001) a prefetched frame for display appropriate to the elapsed real time since playback started. The clip is viewed in real time, even though the network (106) does not necessarily support the data transfer rate required for full playback of the clip.

### CROSS-REFERENCE TO RELATED APPLICATIONS

This application claims the benefit under 35 U.S.C. § 119 of the following co-pending and commonly assigned foreign patent application, which application is incorporated by reference herein:

United Kingdom patent application number GB/01/09/621.3, entitled “DISPLAYING IMAGE DATA,” filed on Apr. 19, 2001, by Marc Bolduc, et. al.

### BACKGROUND OF THE INVENTION

1. Field of the Invention

The present invention relates to viewing image data over a network, and in particular relates to viewing a clip of image frames on a viewing station connected to a network over which the image data is transmitted.

2. Description of the Related Art

Computer networks are used to transfer data of many kinds. Text data does not present much of a problem for today's networks. However, streams of media data, such as continuous sound and images, easily create problems for networks. The difficulty with media data is twofold: firstly, there is a lot of it, and secondly, it is usually desirable to listen to or view the data in real time as it is being transferred.

Both these requirements can be eased by the use of data compression, and it is in this area that attempts to satisfy these requirements are most numerous. In particular, developments in the MPEG video format have enabled streaming of reasonable quality audio and low quality video, over the Internet, even when the connection is made by a telephone line and has a low bandwidth. The widespread adoption of compression standards has introduced audio and video to the home computer, upon which it is now possible to assemble and composite home movies of increasing duration and quality.

Professional digital image processing encompasses both video and, increasingly, high quality film editing. The amount of data in a single frame of film can be as much as forty megabytes. Such frames need to be processed and or viewed at a rate of twenty-four frames per second, resulting in extremely high requirements for both data transfer and data processing. Often such transfers cannot be performed in real time over a network, either because the network has too low a bandwidth, or because network traffic is prohibitive. The problem in these high-end systems is the same as in general purpose computing, and it is only a matter of scale.

Data compression can be used to minimise the difficulty of supplying media data over a network, whether that be a high speed specialised video data network, or the Internet. The particular problem that remains is one of predictability: one may choose a level of data compression that seems likely to result in a sustainable reception of the media data, but this is a fixed assumption, and network capacity will vary from second to second. A fixed data rate will always either overestimate or underestimate the capacity of the network, which is forever changing.

In the art, the solution to these requirements is buffering. By fetching a few seconds' worth of media data before it is rendered, two systems are invoked: a prefetch system and a playback system. The prefetch system is a looped set of instructions to transfer as much data as possible into a memory buffer until the buffer is completely full. The playback system is a looped set of instructions to read from the buffer and render the data in real time. While the prefetch loop can vary in speed according to the conditions of the network, the playback rate is fixed. By providing a sufficiently long buffer, intermittent poor performance of the network will be compensated by peaks in data transfer, while playback will always be able to proceed at a constant rate, and generate output in real time, albeit with a constant delay.

The restriction with this approach is that it still makes an assumption about the average rate of data transfer over the network. The inaccuracy of such an assumption can be compensated by using longer buffers. This is why media playback over the Internet is usually preceded by several seconds of inactivity, perhaps several minutes, while the playback buffer is initially filled.

In the specialised world of video and film editing, the ability to preview a clip of image data over a network is valuable. While working on the compositing of a new film, several clips will be located remotely on a frame store. The operator of an image processing station will not wish to transfer a clip over the network unless said operator is certain that it contains the material intended for work thereon. Transferring the clip can take a lot of time, so it is often required that a preview is made first. However, even a quick preview can result in network capacity being exceeded, especially when there is a lot of traffic. Alternatively large buffers can be used, possibly requiring several minutes to fill, thus making the preview process less worthwhile, compared to simply loading the whole clip and viewing it once all the image frames are locally accessible.

### BRIEF SUMMARY OF THE INVENTION

According to a first aspect of the present invention, there is provided apparatus for viewing image data, comprising display means, processing means and network connecting means for transferring frames of said image data over a network from a remotely connected frame source; said image data comprises a plurality of image frames, and has a frame rate from which may be inferred a due time for display of each frame in a sequence of frames in said image data; said frame source returns a frame in response to a frame request issued over said network; wherein said processing means is configured to play a clip by: displaying selected frames from said frame source, on said display means, at their due time; and skipping frames in said frame sequence in response to an indication of the data transfer rate of said network

### BRIEF DESCRIPTION OF THE SEVERAL VIEWS OF THE DRAWINGS

FIG. 1 shows a network with an image processing station and a frame store, the image processing station including a monitor and a processing system;

FIG. 2 details operations performed by a user of the image processing station shown in FIG. 1, including a step in which a clip is previewed;

FIG. 3 details a view on the monitor shown in FIG. 1;

FIG. 4 details components of the processing system shown in FIG. 1, including processors and a main memory;

FIG. 5 details the contents of the main memory shown in FIG. 4, as they would appear during the preview step shown in FIG. 2, including player instructions;

FIG. 6 summarises steps performed by the processors shown in FIG. 4 when executing the player instructions shown in FIG. 5, including a step of waiting for the user to end playback;

FIG. 7 summarises threads operating during playback of a clip that are active during the step of waiting for a user to end playback shown in FIG. 6, including a prefetch thread and a playback thread;

FIG. 8 summarises the invention, including details of the prefetch thread and the playback thread shown in FIG. 7, and including steps of prefetching another frame, displaying a frame and synchronising prefetch;

FIG. 9 details the step of prefetching another frame shown in FIG. 8;

FIG. 10 details the step of displaying a frame shown in FIG. 8;

FIG. 11 details the step of synchronising prefetch shown in FIG. 8, including a step of updating the skip rate;

FIG. 12 details equations relating to the step of updating the skip rate shown in FIG. 11; and

FIG. 13 details the step of updating the skip rate, shown in FIG. 11.

### BEST MODE FOR CARRYING OUT THE INVENTION

The invention will now be described by way of example only with reference to the accompanying drawings.

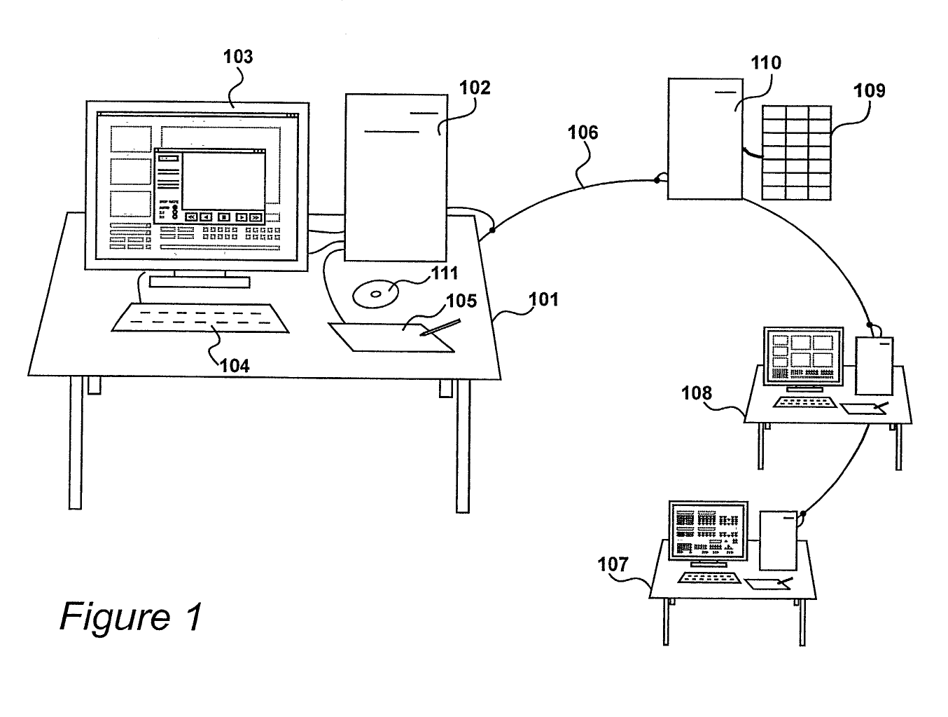

FIG. 1

A system for processing image data is shown in FIG. 1. A first image processing station 101 comprises a processing system 102, a monitor 103, a keyboard 104 and a graphics tablet 105. The processing system 102 is configured to perform operations for the editing and viewing of image clips. A clip comprises a sequence of image frames that are displayed on the monitor 103 at a regular rate, depending upon the format of the clip that is being played. Several standards are known, notably NTSC, which has a frame rate of thirty frames per second, PAL, which has twenty-five frames per second, and cinematographic film, which usually has a playback rate of twenty-four frames per second. The resolution of the frames affects the amount of data that needs to be transferred in order to view a clip at its required rate.

Editing of clips is increasingly performed using digital processing equipment as shown in FIG. 1. Instructions for image processing may be installed on the processing system 102 from a CDROM 111, or alternatively by file transfer over the Internet. Once the image application instructions are installed, a user at the image processing station 101 is able to combine several pre-recorded clips together, apply effects, crossfades, color adjustments and so on, in order to generate a fully finished work, in the form of image data for broadcast or use in part of a film. In the system shown in FIG. 1, the first image processing station 101 is connected to a network 106, over which image data may be transferred. A second image processing station 107 and a third image processing station 108 are also connected to the network 106, and these may be configured to perform similar functions to those of the first image processing station.

Image data is stored remotely in a frame store 109. The frame store comprises a number of hard disk drives, connected together in a RAID (Redundant Array of Inexpensive Disks) configuration. This configuration facilitates high storage capacity, high reliability and high access speed for the image data. Additional frame stores may be located at each of the image processing stations, depending upon the nature of the work that is to be done. The frame store 109 is connected to a second processing system 110, through which image data is transferred to and from the network 106, and thereby to the connected image processing stations.

In a typical workflow, the user of the first image processing station edits a clip of image data. However, before editing can commence, it is necessary for the user to download the clip from the frame store 109. Sometimes the user will need to browse several clips, or sections of a long clip, before the required image data can be identified. In many cases, the amount of data contained in a clip will put a severe strain upon the network 106. Several image processing stations are connected to the network 106, and so the problem of network transfer is made worse by the unpredictable nature of network traffic.

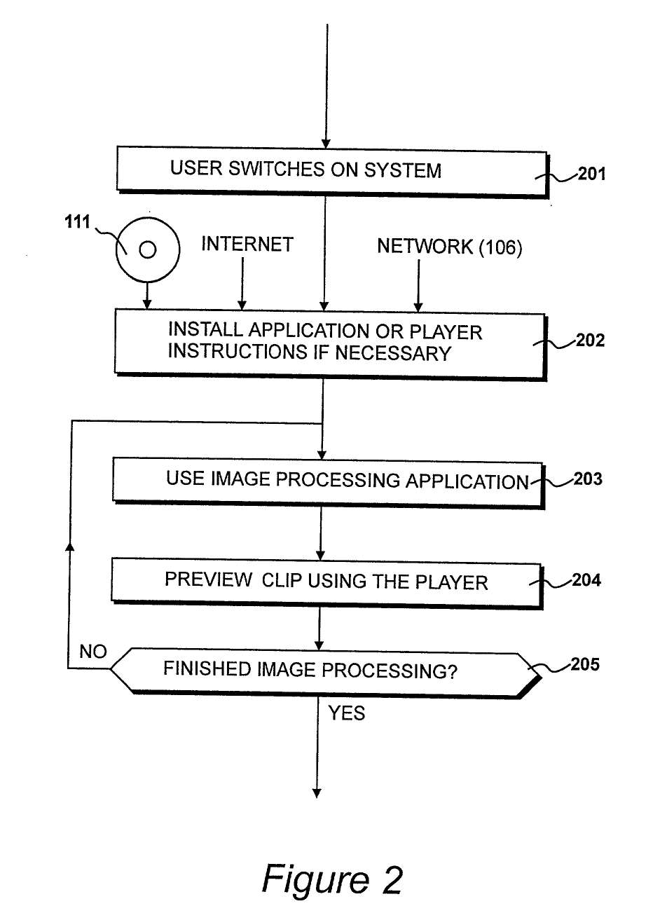

FIG. 2

The workflow of a user at the first image processing station 101 is summarised in FIG. 2. At step 201 the user switches on the processing system 102. At step 202 the user can, if necessary, install the image processing instructions, including player instructions. The player instructions may be installed separately, for example as a plug-in. Instructions may be installed from CDROM 111, the Internet, or over the network 106 from another processing station. At step 203 the image processing instructions are started. At step 204, the user previews a clip from the frame store 109, using the clip player. When the clip player is in use, the image processing station is performing the function of a viewing station, which in another embodiment may take the form of a personal digital assistant (PDA) connected to a wireless network, for example.

At step 205 the user may continue with more image processing, or alternatively, once all image processing is complete, this step finishes the workflow.

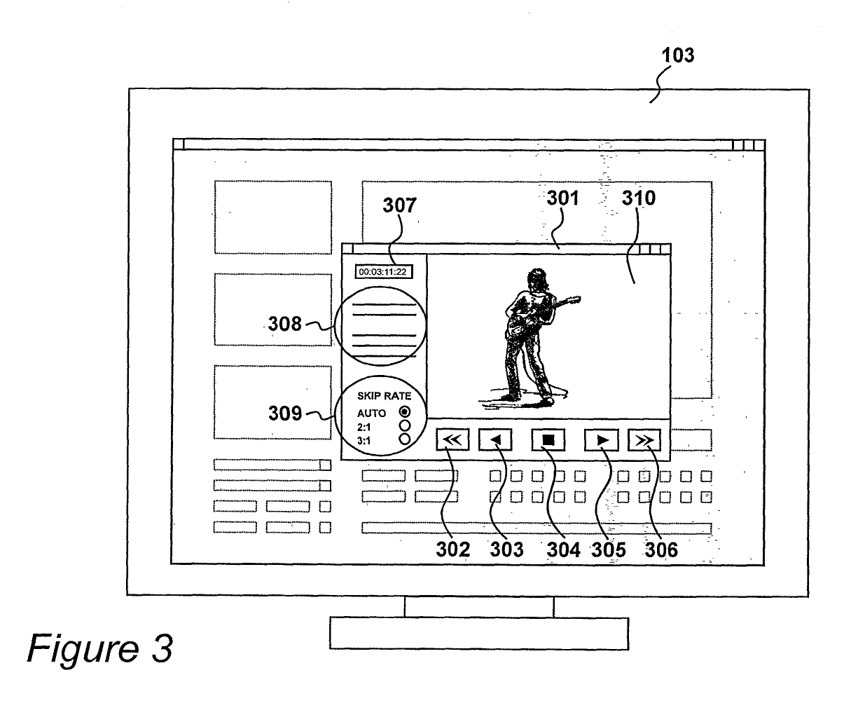

FIG. 3

When the user instructs the processing system 102 to execute clip player instructions at step 204, a window containing the player's user interface is displayed upon the monitor 103. The player's appearance on the monitor 103 is detailed in FIG. 3. The player 301 includes a rewind control 302, a reverse play control 303, a stop control 304, a forward play control 305 and a fast forward control 306. A timecode display 307 indicates the timecode for the currently displayed clip frame. Several text fields 308 are provided for the selection of different clips in the frame store 109, and for facilitating start of play from any frame within a clip.

Controls for selecting a skip rate are shown at 309. In the present embodiment, the skip rate may be selected as being automatic, 2:1 or 3:1. The skip rate may be set by the user, or automatically by the player, in order to facilitate optimal playback of a clip over the network 106. The clip images are displayed in a window 310 of the player.

When the user previews clips on the player, frames are always displayed at their correct time, and this is achieved by skipping some frames when this becomes necessary. Regardless of the data capacity of the network, a clip having a duration of one minute will always complete playback in one minute. The user will therefore see all actions portrayed in the clip take place with their timing preserved. A loss of network bandwidth availability will only result in a degradation in smoothness of action, not a modification of the rate at which the recorded events unfold.

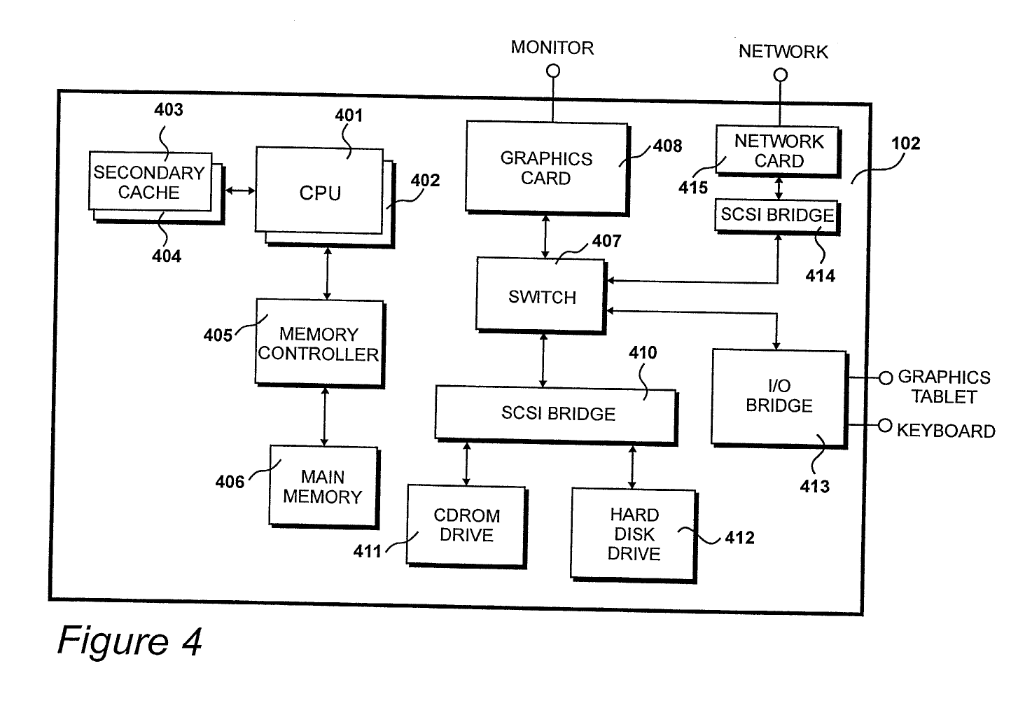

FIG. 4

The processing system 102 shown in FIG. 1 is detailed in FIG. 4. The processing system 102 is an Octane™ produced by Silicon Graphics Inc. It comprises two central processing units 401 and 402 operating in parallel. Each of these processors is a MIPS R12000 manufactured by MIPS Technologies Incorporated, of Mountain View, Calif. Each of these processors 401 and 402 has a dedicated secondary cache memory 403 and 404 that facilitate per-CPU storage of frequently used instructions and data. Each CPU 401 and 402 includes separate primary instruction and data cache memory circuits on the same chip, thereby facilitating an additional level of processing improvement. A memory controller 405 provides a common connection between the processors 401 and 402 and a main memory 406. The main memory 406 comprises two gigabytes of dynamic RAM.

The memory controller 405 further facilitates connectivity between the aforementioned components of the processing system 102 and a high bandwidth non-blocking crossbar switch 407. The switch makes it possible to provide a direct high bandwidth connection between any of several attached circuits. These include a graphics card 408. The graphics card 408 generally receives instructions from the processors 401 and 402 to perform various types of graphical image rendering processes, resulting in images, and clips being rendered in real time on the monitor 103.

A SCSI bridge 410 facilitates connection between the crossbar switch 407 and a DVD/CDROM drive 411. The DVD/CDROM drive provides a convenient way of loading large quantities of data, and is typically used to install instructions for the processing system 102 onto a hard disk drive 412. Once installed, instructions located on the hard disk drive 412 may be transferred into the main memory 406 for execution by the processors 401 and 402. An input output (I/O) bridge 413 provides an interface for the graphics tablet 105 and the keyboard 104, through which the user interacts with the processing system 102. A second SCSI bridge 414 provides an interface with a network card 102, that facilitates a network connection between the processing system 102 and the network 106.

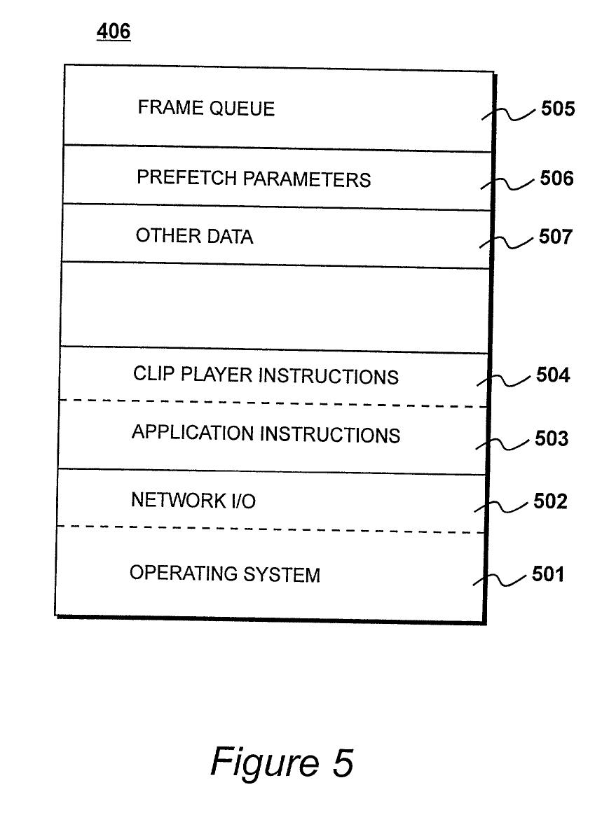

FIG. 5

The contents of the main memory 406 shown in FIG. 4, as they would appear during step 204 in FIG. 2, are detailed in FIG. 5. An operating system 501 provides common system functionality for application instructions running on the processing system 501. Preferably the operating system 501 is the Irix™ operating system, available from Silicon Graphics Inc. Included with the operating system instructions, are instructions 502 for making a data transfer over the network 106. Application instructions 503 include instructions for clip editing and effects processing. Included with the application instructions are player instructions 504.

Memory contents 501 to 504 comprise instructions and static data components that define how the processing system 102 operates. In addition to these components, are dynamic memory contents 505 to 507, whose constituents change as a result of instruction execution upon the processors 401 and 402. A frame queue 505 is created by the player instructions 504 in order to temporarily store frames that have been prefetched from the frame store 109 during playback. Prefetch parameters 506 determine which frames are to be fetched into the frame queue 505. Other data 507 represents all other data used by the operating system and applications running on the processing system 102.

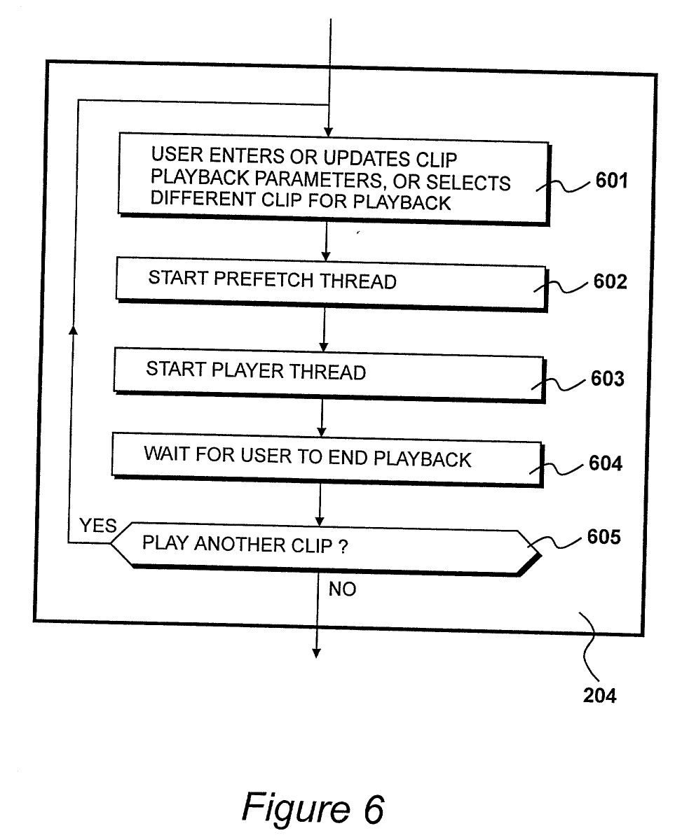

FIG. 6

Steps performed by the processing system 102 during step 204 in FIG. 2, in which a clip is played, are detailed in FIG. 6. At step 601 the user operates the keyboard 104 and or graphics tablet 105 to interact with the player 301, to define which clip to play. The user may also set a start frame or time anywhere within the clip from which playback will begin. The user can also set the skip rate 309 to “automatic”, “2:1” or “3:1”. At step 602, a prefetch thread is started. This results in there being two concurrent threads of execution: the prefetch thread and the main thread of execution.

The prefetch thread is a process that independently fetches frames from the frame store 109 via the network 106. The frames are stored into the frame queue 505, which has a fixed length of ten frames.

At step 603 a player thread is created. This thread reads frames from the frame queue 505 and displays them in accordance with the time at which they are intended for display.

The main thread of execution waits at step 604, until the user performs an action that stops playback, for example, clicking on the stop button 304. When playback ends, both the prefetch thread and the player thread are stopped. At step 605 the user is presented with a choice of interactions, for instance said user wishes to play another clip, or perhaps the same clip from a different start point. If so, control is directed back to step 601. Alternatively this completes the steps performed while viewing a clip using the player 301.

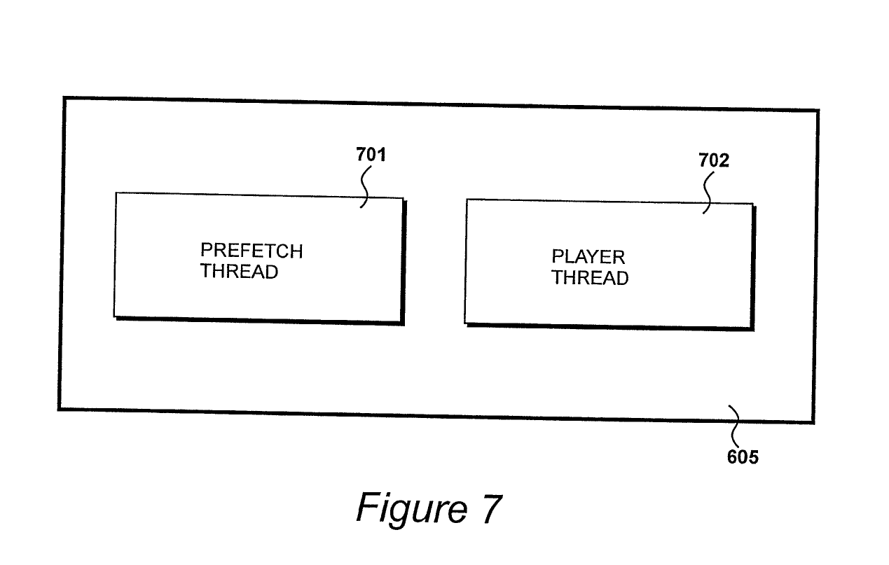

FIG. 7

The prefetch thread 701 and the player thread 702 are both executed concurrently during step 604 of FIG. 6. This is illustrated by FIG. 7. Although the two threads 701, 702 may be considered as separate simultaneous processes, they share access to the frame queue 505 and the prefetch parameters 506.

A clip comprises multiple frames of image data that are intended to be viewed on a screen at regular intervals, for example at a rate of thirty frames per second. Knowledge of the frame rate implies a due time for display of each frame within the clip. Due time of a frame, and the frame rate for a clip, are both examples of a frame timing parameter. If the clip is to be played back from a frame different from the first frame of the clip, then this may be taken into account, and a different set of due times is implied for each of the frames that are displayed during a playback. A convenient unit of time for a clip is the frame, and, in combination with the frame rate parameter, this can be used to provide all the timing information about a clip that is necessary for correct timing of playback.

In addition to playing back frames from the frame store 109, frames may be rendered remotely by a rendering process running on a remote processing system 109, each frame being rendered in response to a request for a frame from the image processing system 101 on which the player 301 is running. The frames created in this way may be considered as a frame source, from which a clip may be viewed. For the purposes of the present embodiment, a clip is any sequence of image frames intended for display at regular intervals. The Internet is a suitable network for the transfer of image data to the player, and an advantage is obtained over known techniques of the art, given that the rate of data transfer over the Internet is highly unpredictable.

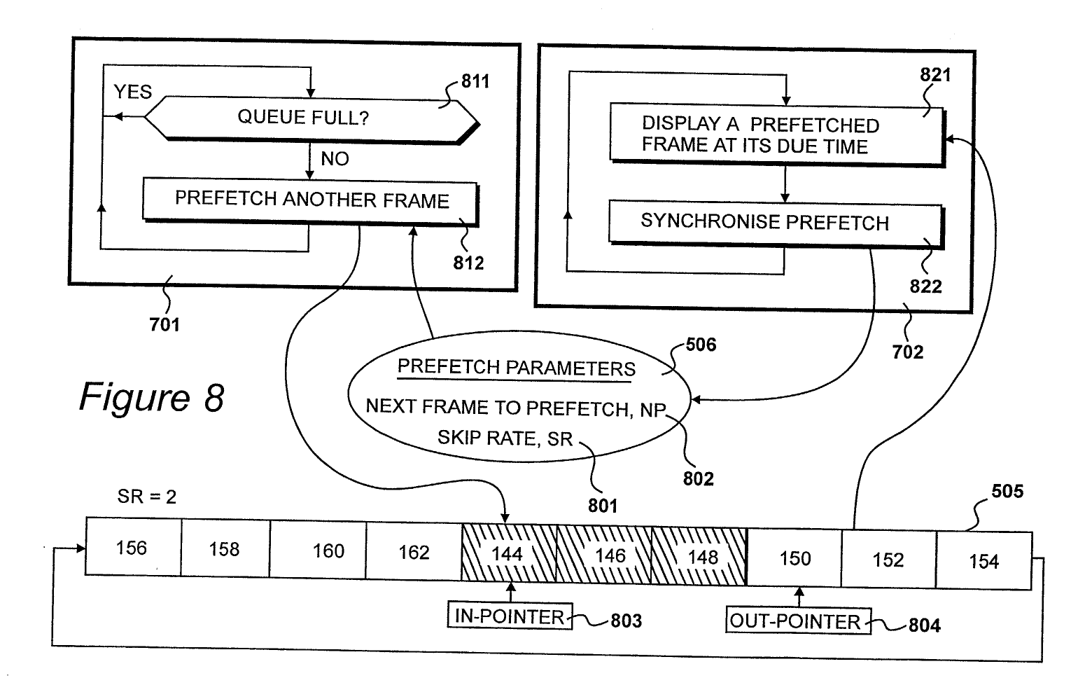

FIG. 8

The invention is summarised in FIG. 8. In this Figure, both the prefetch and the player threads are detailed, at 701 and 702 respectively. The prefetch parameters 506 form a link from the player thread 702 to the prefetch thread 701. The prefetch parameters include a skip rate, SR, 801 and a next frame to prefetch, NP, 802. The prefetch thread 701 writes frames to the frame queue 505, and the player thread 702 reads frames from the queue 505 at their due time. The skip rate, SR, causes the prefetch thread to skip frames within the sequence of frames in a clip. In this way, the overall bandwidth required for clip playback is reduced, but each frame in the queue is still displayed at its correct due time, thus maintaining the timing integrity of the clip.

The frame queue 505 has an in-pointer 803 and an out-pointer 804. The queue is eight frames long, and is arranged as a circular buffer. In the example shown in FIG. 8, frame numbers 144, 146 and 148 have already been displayed, and the out-pointer 804 indicates frame number 150 as being the frame currently on display. As the player thread 702 reads frames from the queue 505, the out-pointer 804 will advance through frames 150, 152, 154 and so on, while the in-pointer will advance with new frames 160, 162, and so on, assuming that the skip rate remains unchanged from its value of two. The in-pointer and out-pointer can advance at different rates: the out-pointer is under control of the player thread, which displays frames in accordance with a match between the due time of a frame, and the elapsed real time since playback started. The prefetch thread fetches frames according to the skip rate, and so the in-pointer 803 advances according to the relation between the amount of data transferred and the data bandwidth available for transfer over the network.

It is possible for the queue 505 to run out of frames ready for display, if the out-pointer catches up with the in-pointer. This happens if the skip rate is set too low. The skip rate may be increased manually to 3:1 or, alternatively, an automatic mode can be selected, which adjusts the skip rate in accordance with a constantly updated measurement of the network data transfer rate.

The prefetch thread 701 comprises two main steps. At step 811 a question is asked as to whether the frame queue 505 is already full. If so, no action is taken, and this question is repeated until there is room for a new frame in the queue 505. At step 812 another frame is prefetched. The frame number of the next frame is given by the prefetch parameters, one or both of which, may have been updated by the player thread 702. Having prefetched another frame at step 812, control is directed back to step 811.

The player thread 702 comprises two main steps. At step 821 a frame is displayed at its due time. New frames are not always displayed, as it is often the case that the frame already on display is the one that is most appropriate for the current state of elapsed real time. At step 822 the prefetch thread is synchronised by updating one or several prefetch parameters 506. After step 822, control is directed to step 821. Synchronisation, as used in this description, means the attempt to ensure synchronous movement of the in-pointer and the out-pointer of the frame queue, such that neither overtakes the other, and a constant gap of several new frames is maintained. The prefetch parameters control the amount of data that is transferred, so that the player thread 702 can display new frames as frequently as possible, but always at their correct due time.

The clip player 301 is optimised for the best possible smoothness in accordance with the changing data transfer capacity of the network, while maintaining the timing integrity of the clip. So, for example, a clip that lasts one minute ten seconds, will play back in that time, even though the network transfer rate may changes dramatically throughout playback. During playback, the smoothness changes because frames are being skipped to a greater or lesser extent, but the timing of events depicted in the clip, is preserved.

The implementation of steps within the two threads 701 and 702 may vary according to implementation. It is possible, for example, to use only a single thread, but with a more complex allocation of processing time for the central processors 401 and 402. Alternatively, the division of operations between the threads may be changed, or more threads used, when optimising an implementation for the environment in which the clip player is intended to operate.

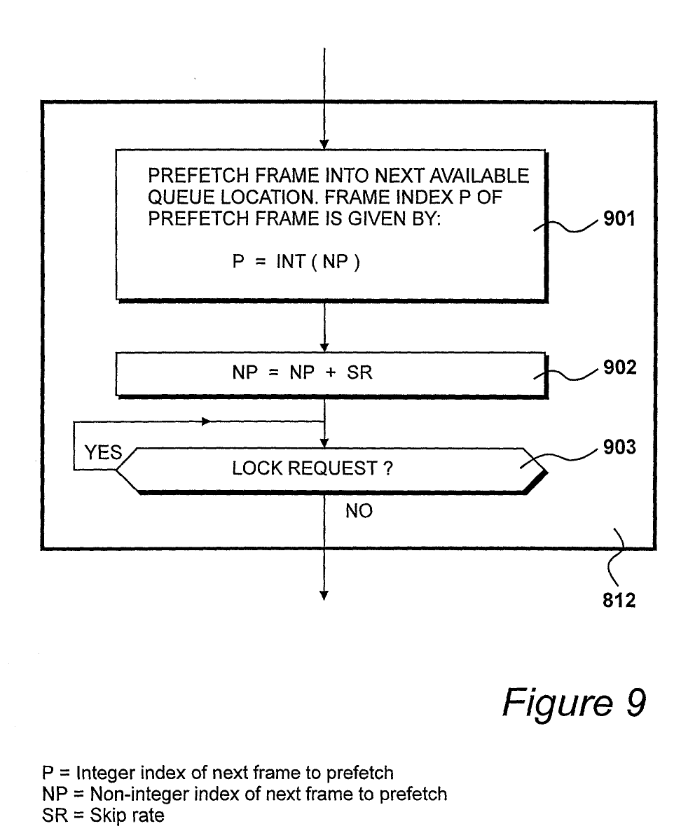

FIG. 9

FIGS. 9 to 13 contain equations within which the following parameters are used:

| | |
|---|---|
| SR | Skip Rate |
| NP | Next Prefetch frame number |
| F | Current playback Frame number |
| SF | Start Frame from which playback commenced |
| T | Elapsed real time since playback started |
| FRC | Frame Rate for Clip |
| TN | Time to transfer last frame over network |
| D | Number of unread frames in queue |
| P | Integer value derived from NP |
| S | Integer value derived from F |

The step 812 of prefetching another frame, shown as part of the prefetch thread 701 in FIG. 8, is detailed in FIG. 9. At step 901 a frame is prefetched into the next available location of the frame queue 505. This location is pointed to by the in-pointer 803, which is automatically incremented as a result of this step. The frame number, or index, is derived from the value NP, 802, which is a prefetch parameter 506. When automatic mode is selected, the player generates fractional values of NP, for example 58.932. These fractional values are used so that over several iterations, the fractional parts of the parameters are accumulated and accuracy is not lost. However, when a frame number is required, this must be an integer value, so the frame requested would be frame fifty-eight, which is the integer portion of 58.932.

Once the frame has been prefetched into the frame queue 505, the value of NP is updated by the prefetch thread at step 902, by adding the skip rate SR to it. At step 903 a question is asked as to whether a lock request has been made. A lock request can be made by the player thread 702. When the lock is granted, step 903 continues in a loop, and the player thread is then free to make modifications to a prefetch parameter without causing interference with any of steps 901 or 902. For example, the player thread may update the value of NP, which can be done during the loop of step 903 without interfering with the critical operations of steps 901 and 902. It will then be certain that the value of NP set by the player thread 702 will be used at step 901. Once any such operations have been completed, the lock is released, and this completes the step 812 for prefetching another frame.

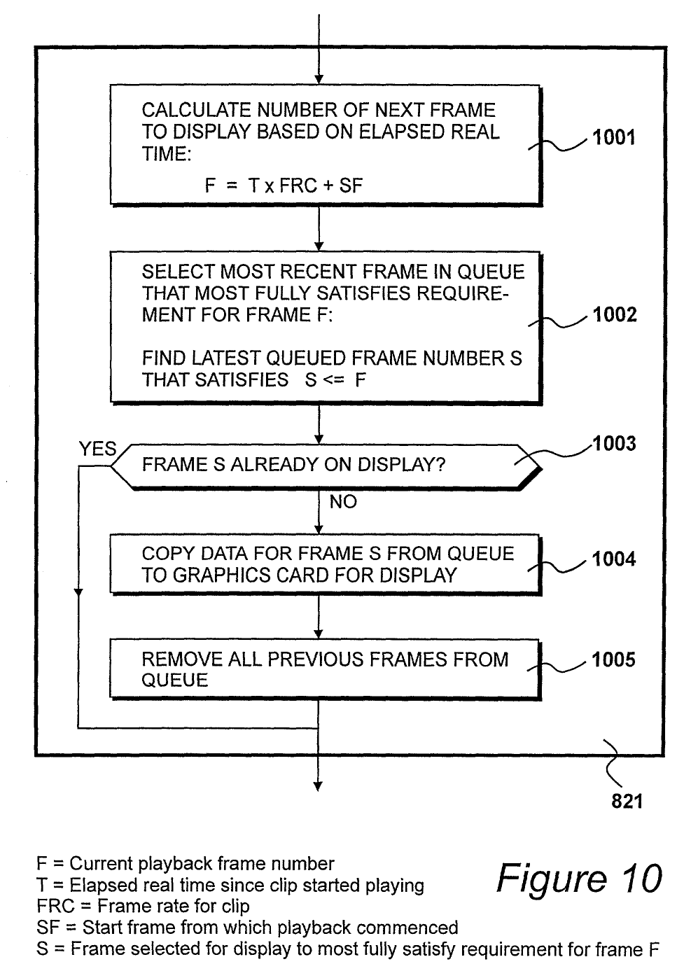

FIG. 10

Displaying a next frame at its due time is done at step 821 by the player thread, as shown in FIG. 8. This step is detailed in FIG. 10. At step 1001 a calculation is made of the next frame to display, based upon the elapsed real time. This calculation takes into account the frame rate for the clip FRC, which is a frame timing parameter. A second frame timing parameter is also used, SF, the start frame number from which playback commenced, as it is not always the case that playback will start from frame zero. The elapsed real time of playback, T, is used to control the value produced, so that whichever frame is selected from the queue for display, this selection is made in response to the real time; the time experienced by the person looking at the player 301. The frames that are being fetched from the frame store are not necessarily continuous, and need not even be in order, provided they are fetched before their respective due times for display. The result of the calculation made at step 1001 is a fractional frame value, F.

At step 1002 the queue is examined to find the most recent frame S that satisfies the condition where S is less than or equal to F. Thus it is possible that on several iterations of step 821, the same frame S will be identified at step 1002, until enough real time has elapsed to select the next prefetched frame in the frame queue 505.

At step 1003 a question is asked as to whether frame S is already on display. If so, there is no need to perform any additional displaying operations. Alternatively, if a different frame now needs to be displayed, control is directed to step 1004. At this step, data is transferred from the frame queue 505 to the graphics card, for display on the monitor 103. At step 1005 all frames in the queue having an earlier frame number than frame S, are removed. This is achieved by incrementing the out-pointer 804 to the currently displayed frame, thus making room for one or several new frames to be fetched by the prefetch thread 701.

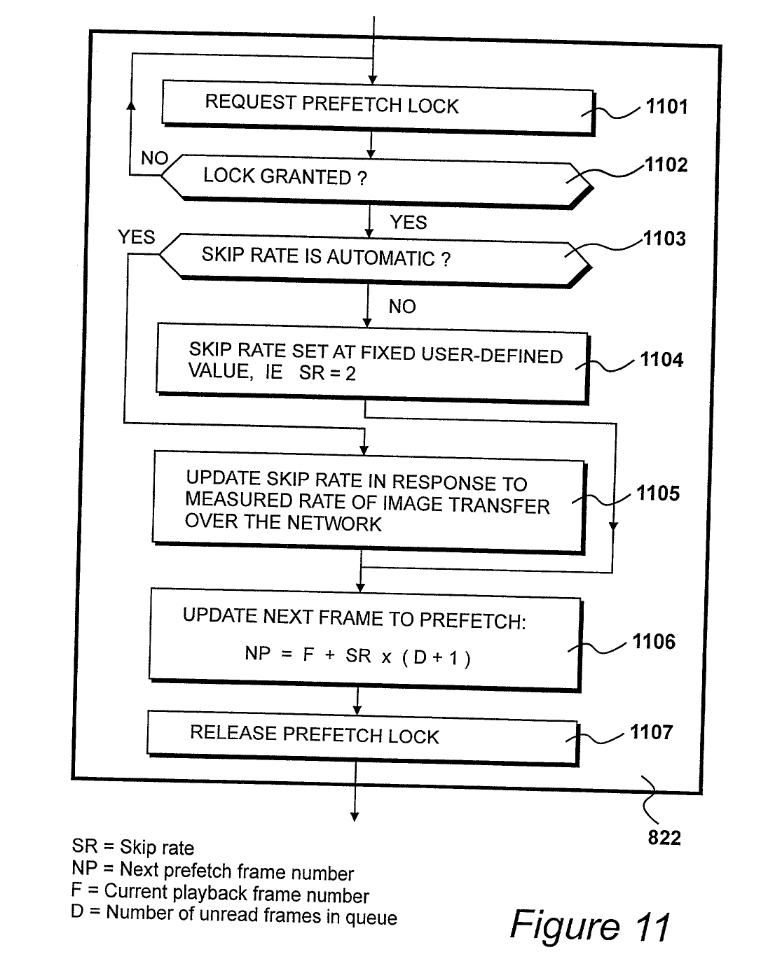

FIG. 11

Prefetch synchronisation, as performed at step 822 in FIG. 8, is detailed in FIG. 11. At step 1101 the prefetch lock is requested. At step 1102 a question is asked as to whether the prefetch lock has been granted. If not, control is directed to step 1 101, alternatively the prefetch lock has been granted and this ensures that the prefetch thread is safely locked in the loop formed at step 903 in FIG. 9. Thereafter it is safe for the player thread to update the prefetch parameters 506, and control is directed to step 1103.

At step 1103 a question is asked as to whether the skip rate has been set to “automatic”. This is controlled by the user by the interface component indicated at 309 in FIG. 3. If the skip rate is not automatic, it will have been set at a fixed rate, for example 2:1, as indicated at step 1104. A rate of 2:1 is defined by setting the skip rate SR to the value two. Alternatively if the skip rate is automatic, control is directed to step 1105.

At step 1105 the skip rate is updated in response to the measured rate of image transfer over the network. This results in a fractional value for SR being set, for example 3.137. Once the skip rate has been determined, whether manually or automatically, control is directed to step 1106. At step 1106 the next frame to prefetch is defined by the value of NP. NP may take a fractional value, as required when the skip rate is set automatically, and this is then converted into an integer at step 901 in FIG. 9. The next frame to prefetch is calculated with reference to a value D, which defines the number of available unread frames in the queue. For example, if three frames, twenty-two, twenty-four and twenty-six have yet to be displayed, then the next frame to prefetch would be twenty-eight. If the resulting value of NP is less than its previous value, then the previous value is used instead. This may occur if the skip rate changes dramatically as a result in an increase in available network bandwidth.

Step 1106 is a second method of updating the value of NP, the first being performed at step 902. The results of step 902 are used whenever step 1106 has not had a chance to generate a new value. The calculation performed at step 1106 has the effect of correcting any lead or lag between the in-pointer and out-pointer of the frame queue. Synchronisation of their rate of progression through the queue is achieved by automatically calculating the skip rate at step 1105. When the skip rate has been set to a fixed value, then the calculation performed at step 1106 will ensure that the player still performs at a reasonable level of efficiency.

At step 1107, the prefetch lock is released, thus enabling both threads 701 and 702 to continue their execution independently.

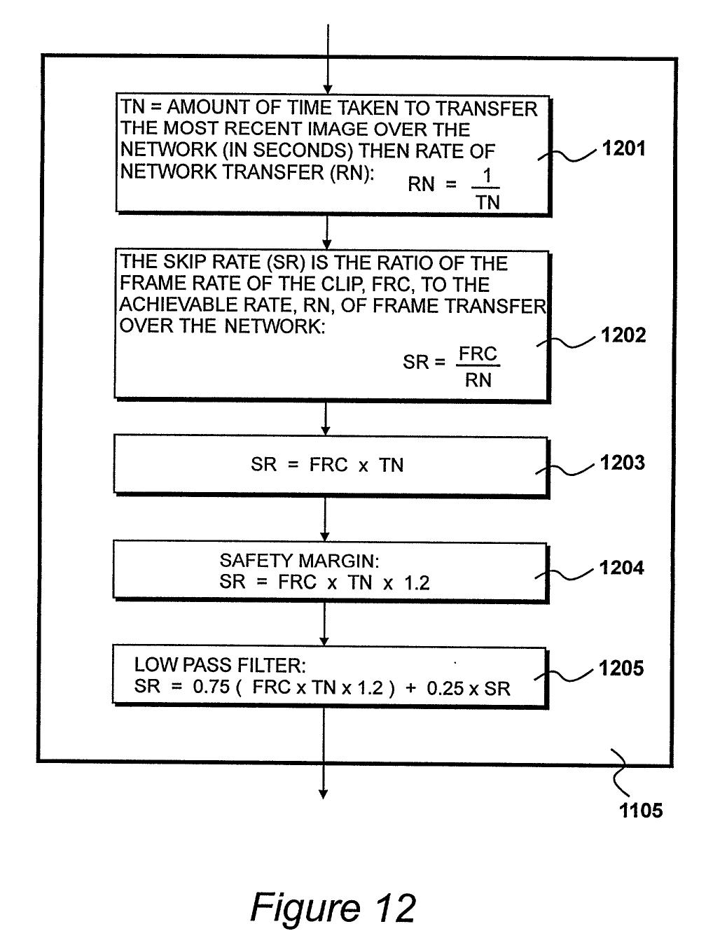

FIG. 12

The derivation of relationships used in step 1105, in which the skip rate is updated automatically, is detailed in FIG. 12. The time TN for the most recent image frame to download from the network provides a measure RN of the network capacity 1201. In its simplest form, the skip rate SR 1202 is given by dividing the frame rate for the clip, FRC, and the time, TN required to download the last frame. However, a safety margin 1204 can be applied, to avoid using up all the available network capacity for a player on one particular workstation. In the preferred embodiment this is set to a value of 1.2, although other values, depending upon experiment, may also be chosen to optimise performance for several users on the network. The rate of data transfer over the network may vary considerably from frame to frame, and so an average of several measurements is used. A low pass filter to achieve this is shown at 1201 in FIG. 12. In an alternative embodiment, an adaptive statistical model is used to predict the likely transfer bandwidth over the network, based upon several statistical variables generated from previous measurements of the time taken to download a frame.

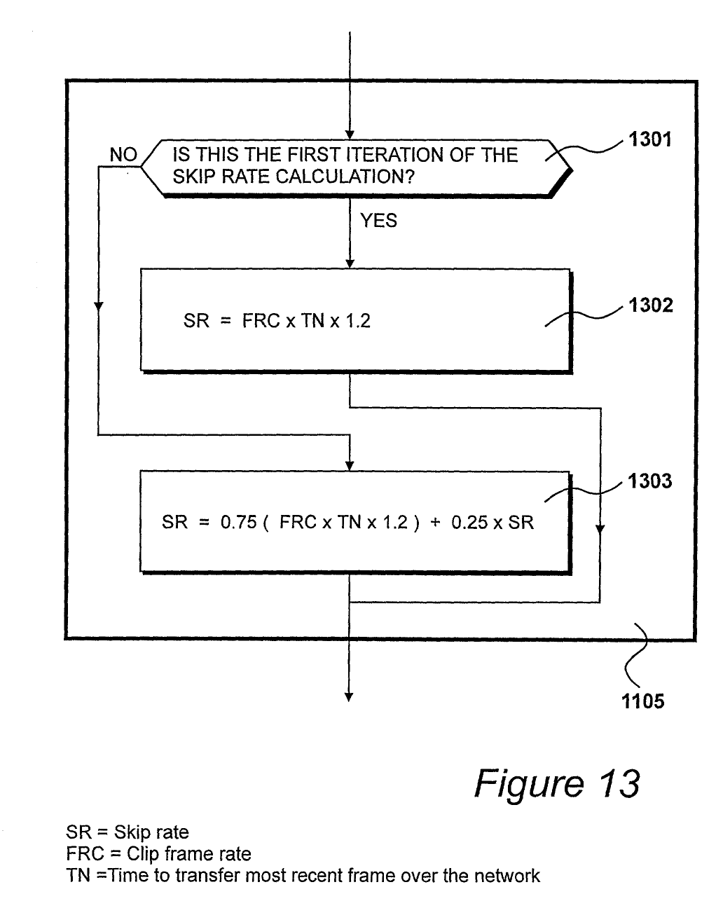

FIG. 13

Updating the skip rate automatically, performed at step 1105 in FIG. 11, is detailed in FIG. 13. At step 1301 a question is asked as to whether this is the first iteration of the skip rate calculation. If so, control is directed to step 1302, where the skip rate is calculated without reference to previous values. Alternatively, control is directed to step 1303, where the previous value for SR is included in the new calculation of SR, resulting in the filtering effect. Steps 1302 and 1303 may be replaced with an adaptive statistical model in an alternative embodiment.

The invention enables high bandwidth clips to be viewed over a low bandwidth network by skipping frames. The clip completes playback in its correct time, with the only distortion being in the form of a lack of smoothness as frames are skipped. The events depicted by the clip are not speeded up or slowed down. The skip rate may be modified automatically, either by updating a next frame to fetch, NP, and or by modifying a skip rate, SR, or other parameter that achieves the same effect.

The steps that are performed include:

(a) selecting a next frame for preloading by skipping at least one frame in the clip's sequence, as performed at step 902 and or step 1106;

(b) preloading a next frame from a frame source into a queue of frames 505, as performed at step 901;

(c) displaying a preloaded frame at its due time, as performed at step 821;

(d) processing elapsed real time T since the clip started playing with a frame timing parameter, for example as performed at step 1001, in which the frame timing parameter is FRC, the frame rate of the clip; and

(e) updating the number of frames to skip in response to step (d), as performed at step 1105 or step 1106.

As these steps are repeated, and implemented preferably in the form of multiple concurrent threads, their order is not necessarily important. It will be understood by those skilled in the art, that implementation can be varied considerably, in order to achieve the best effect within the specific system in which the invention is to be deployed.

1. Apparatus for viewing image data, comprising:
(a) display means;
(b) network connecting means for transferring frames of said image data over a network from a remotely connected frame source, wherein:
(i) said image data comprises a plurality of image frames and has a frame rate from which may be inferred a due time for display of each frame in a sequence of frames in said image data;
(ii) said frame source returns a frame in response to a frame request issued over said network; and
(c) processing means configured to play a clip by:
(i) displaying selected frames from said frame source, on said display means, at their due time; and
(ii) skipping frames in said frame sequence in response to an indication of the data transfer rate of said network.

2. Apparatus according to claim 1, wherein said indication of the data transfer rate is provided by a comparison of the relative position of an input and an output pointer in a queue of frames that have been selected for display.

3. Apparatus according to claim 1, wherein said frame source includes means for storing pre-rendered image frames.

4. Apparatus according to claim 1, wherein said frames are skipped in response to a prediction of a network data transfer rate.

5. Apparatus according to claim 1, wherein frames are prefetched into a frame queue prior to their due time.

6. Apparatus according to claim 1, wherein a frame skip rate is defined by a user.

7. Apparatus according to claim 1, wherein a frame is selected for display by processing its due time with elapsed real time since playback started.

8. Apparatus for displaying image data, comprising:
(a) image data comprising a plurality of image frames, sequences of said frames being organised into clips, each clip having a frame rate, and each frame in a clip thereby having a due time for display with respect to a start time for playing the clip;
(b) display means;
(c) memory means;
(d) network connecting means for enabling transfer of image data over a network from a frame source remotely connected to said network; and
(e) processing means configured to perform operations to play a clip from said frame source by:
(i) selecting a next frame for preloading by skipping at least one frame in the clip's frame sequence;
(ii) preloading a frame from said frame source into a frame queue in said memory means;
(iii) displaying a preloaded frame at its due time;
(iv) processing elapsed real time since the clip started playing with a frame timing parameter; and
(v) updating the number of frames to skip in response to said processing of elapsed real time.

9. Apparatus according to claim 8, wherein said frame timing parameter is the due time for a frame.

10. Apparatus according to claim 8, wherein instructions for the processing means are executed as multiple threads.

11. A method of displaying image data on an image viewing station, wherein:
(a) the image viewing station comprises display means, processing means, and network connecting means for transferring frames of said image data over a network from a remotely connected frame source;
(b) said image data comprises a plurality of image frames, and has a frame rate from which may be inferred a due time for display of each frame in a sequence of frames in said image data;
(c) said frame source returns a frame in response to a frame request issued over said network; and
(d) said processing means is configured to play a clip in which said method comprises:
(i) displaying selected frames from said frame source, on said display means, at their due time; and
(ii) skipping frames in said frame sequence in response to an indication of the data transfer rate of said network.

12. A method according to claim 11, wherein said indication of the data transfer rate is provided by a comparison of the relative position of an input and an output pointer in a queue of frames that have been selected for display.

13. A method according to claim 11, wherein said frame source includes means for storing pre-rendered image frames.

14. A method according to claim 11, wherein said frames are skipped in response to a prediction of a network data transfer rate.

15. A method according to claim 11, wherein frames are prefetched into a frame queue prior to their due time.

16. A method according to claim 11, wherein a frame skip rate is defined by a user.

17. A method according to claim 11, wherein a frame is selected for display by processing its due time with elapsed real time since playback started.

18. A method for displaying image data on an image viewing station that comprises display means, processing means, memory means and network connecting means for enabling transfer of image data over a network from a frame source remotely connected to said network, wherein:
said image data comprises a plurality of image frames, sequences of said frames being organised into clips, each clip having a frame rate, and each frame in a clip thereby having a due time for display with respect to a start time for playing the clip;
said processing means is configured to perform operations to play a clip from said frame source by a method comprising:
(a) selecting a next frame for preloading by skipping at least one frame in the clip's frame sequence;
(b) preloading a frame from said frame source into a frame queue in said memory means;
(c) displaying a preloaded frame at its due time;
(d) processing elapsed real time since the clip started playing with a frame timing parameter; and
(e) updating the number of frames to skip in response to said processing of elapsed real time.

19. A method according to claim 18, wherein said frame timing parameter is the due time for a frame.

20. A method according to claim 18, wherein instructions for the processing means are executed as multiple threads.

21. A data structure upon a machine readable medium, comprising instructions for controlling an image viewing system to perform a method for viewing image data, said viewing system comprising:
display means, processing means and network connecting means for transferring frames of said image data over a network from a remotely connected frame source;
said image data comprising a plurality of image frames, and has a frame rate from which may be inferred a due time for display of each frame in a sequence of frames in said image data;
said frame source returns a frame in response to a frame request issued over said network; wherein
said processing means being configurable by said instructions to play a clip in which said method includes:
displaying selected frames from said frame source, on said display means, at their due time; and
skipping frames in said frame sequence in response to an indication of the data transfer rate of said network.

22. A data structure according to claim 21, wherein said indication of the data transfer rate is provided by a comparison of the relative position of an input and an output pointer in a queue of frames that have been selected for display.

23. A data structure according to claim 21, wherein said frame source includes means f or storing pre-rendered image frames.

24. A data structure according to claim 21, wherein said frames are skipped in response to a prediction of a network data transfer rate.

25. A data structure according to claim 21, wherein frames are prefetched into a frame queue prior to their due time.

26. A data structure according to claim 21, wherein a frame skip rate is defined by a user.

27. A data structure according to claim 21, wherein a frame is selected for display by processing its due time with elapsed real time since playback started.

28. A data structure upon a machine readable medium, comprising instructions for controlling an image viewing system to perform a method for viewing image data, said viewing system comprising:
display means, processing means, memory means and network connecting means for enabling transfer of image data over a network from a frame source remotely connected to said network, in which:
said image data comprises a plurality of image frames, sequences of said frames being organised into clips, each clip having a frame rate, and each frame in a clip thereby having a due time for display with respect to a start time for playing the clip; wherein
said processing means is configured to perform operations to play a clip from said frame source by a method comprising:
(a) selecting a next frame for preloading by skipping at least one frame in the clip's frame sequence;
(b) preloading a frame from said frame source into a frame queue in said memory means;
(c) displaying a preloaded frame at its due time;
(d) processing elapsed real time since the clip started playing with a frame timing parameter; and
(e) updating the number of frames to skip in response to said processing of elapsed real time.

29. A data structure according to claim 28, wherein said frame timing parameter is the due time for a frame.

30. A data structure according to claim 28, wherein instructions for steps (a) to (e) will be executed as multiple threads.
